(19) United States
(12) Patent Application Publication
(10) Pub. No.: US 2009/0019292 A1
(43) Pub. Date: Jan. 15, 2009

(54) Secure management of information

(76) Inventors: Bjorn Erik Fransson, Spanga (SE); Hans Stefan Kristian Lynggaard, Lund (SE)

Correspondence Address: BIRCH STEWART KOLASCH & BIRCH, PO BOX 747, FALLS CHURCH, VA, 22040-0747, US

(21) Appl. No.: 11/665,020

(22) PCT Filed: Oct. 10, 2005
(86) PCT No.: PCT/SE05/01489

§ 371 Date: Apr. 10, 2007

Related U.S. Application Data
(60) Provisional application No. 60/617,193, filed on Oct. 12, 2004.
(60) Provisional application No. 60/695,851, filed on Jul. 5, 2005.

(30) Foreign Application Priority Data
Jun. 30, 2005 (SE) 0501520-1

(51) Int. Cl. H04L 9/06

(52) U.S. Cl. 713/193

(57) ABSTRACT

Methods and system are devised to provide security with regard to position data recorded by an electronic pen. The position data originates from a specific area of a position-coding pattern and is destined for a specific Application Service Handler, ASH, which is allocated the specific area of the pattern. The pen stores one or more Pen Application Licenses, PALs, which each includes license data in association with an encryption key, the license data identifying an area of the pattern. The encryption key of a given PAL corresponds to an encryption key of a given ASH. Thus, the PALs enable the pen to encrypt recorded position data, originating from the specific area of the pattern, with the encryption key that is related to the encryption key of the receiving ASH. The license data may further define a group of pens and a validity period, allowing a party generating a PAL to control its use. Generating a PAL may in turn need prior authorization, given by PAL validation data derived from an authorizer. The PAL validation data, which is to be included in the PAL, may set boundaries for the license data that can be included in a PAL, and may also be digitally signed by the authorizer. The pen may be prohibited to install the PAL unless its license data can be properly validated against the PAL validation data.

### CROSS-REFERENCE TO RELATED APPLICATIONS

The present application claims the benefit of U.S. provisional patent application No. 60/617,193, filed on Oct. 12, 2004; Swedish patent application No. 0501520-1, filed on Jun. 30, 2005; and U.S. provisional patent application No. 60/695,851, filed on Jul. 5, 2005, all of which are hereby incorporated by reference.

### TECHNICAL FIELD

The present invention relates to methods and a system for providing security with regard to position data recorded by an electronic pen.

### BACKGROUND OF THE INVENTION

The Applicant of the present invention has developed a system infrastructure in which use is made of products having writing surfaces that are provided with a position code. In such a system, electronic pens, also known as digital devices, are used for writing on the writing surface while at the same time being able to record positions of the position-coded surface. The electronic pen detects the position code by means of a sensor and calculates positions corresponding to written pen strokes.

The position code is part of a position-coding pattern capable of coding co-ordinates of a large number of positions. Thus, the pattern can be seen as forming a virtual surface or reference surface which is defined by all positions that the pattern is capable of coding, different positions on the virtual surface being dedicated for different functions, or services, and/or actors. The virtual surface is typically divided into different subsets, wherein a subset may include confined areas of the pattern. Such confined areas may have a sizes corresponding to that of physical pages, and therefore be denoted pattern pages, each pattern page being represented by a unique page address. In such a case, each absolute position may be represented by a page address and a local position within the associated pattern page.

The electronic pens may have knowledge of the virtual surface, via so-called templates that are pre-stored in the pen to define certain functional areas on the virtual surface. The pen may process the recorded positions based on functions indicated by these templates.

In addition to the electronic pens and a plurality of position-coded products, the system includes a plurality of application servers acting as Application Service Handlers in the system. An Application Service Handler, ASH, effectuates a service on behalf of an electronic pen, such as storing or relaying digital information, initiating transmission of information or items to a recipient etc.

The system infrastructure manages the virtual surface defined by the position code and the information related to this virtual surface, in particular what ASH that is associated with what positions. By associating different areas of the virtual surface with different destination units, information from a pen can be directed to the correct destination unit for processing. For example, the system may include an intermediary server which, upon receipt of one or more absolute positions from a pen, or of a page address, identifies an associated network address of the correct ASH, and directs, or routes, the information data to this network address.

The intermediary server may further associate various management rules with different areas on the virtual surface, e.g. identified by page addresses, which management rules determine how position data of such areas are to be managed, or processed. In particular, such management rules for a certain area may control whether the pen should encrypt the position data, and, if so, what encryption key to use, before transmitting the position data to its intended destination.

The above described virtual surface and exemplifying overall system infrastructures with exemplifying operations, functions and services provided to digital devices, i.e. electronic pens, are further described in the published patent applications US 2002/0091711, US 2003/0046256 and US 2003/0061188, all of which have been filed by the present Applicant and all of which are incorporated herein by reference. It is to be noted that other types of position-coding patterns are equally possible within the scope of the present invention, for example those disclosed in U.S. Pat. No. 6,570,104; U.S. Pat. No. 6,330,976; and US 2004/0085287.

One drawback of such a type of system is that if an ASH associated with the positions of a certain area of the position-coding pattern wishes the pen to apply encryption to position data using a specific encryption key, in order to deploy a secure service in the system, it needs to interact with a intermediary server of the above kind in order to configure the corresponding management rules with such an encryption key.

With regard to the deployment and use of secure services in a system as described above, the Applicant has identified a number of, mutually independent and non-exclusive, desired properties of such deployment and use:

First, it would be desired that a party, such as an administrator of an Application Service Handler, wishing to deploy a new service, in which information is to be transmitted and managed in a secure manner, could deploy such a secure service based on an interaction with the electronic pens only, without requiring the party to interact with other elements of the system infrastructure, such as any intermediary nodes or servers, at the time of deployment of the service;

Second, it would also be desired that that any electronic pen, for which a secure service is deployed, is able to trust the secure service, i.e. trust that any information transmitted when using the service does not end up being utilized by a wrong recipient;

Third, as an electronic pen should be able to use multiple services, different Application Service Handlers should be able to deploy different secure services with regard to one and the same pen, and the pen should be able to trust each of these secure services; and

Fourth, it would also be advantageous if a pen could trust the deployer itself of the secure service, i.e. not only that information is provided only to the deployer of the secure service, but that the deployer has the right to receive the information from the pen, or that the deployer has been qualified by the system infrastructure as a deployer that can be trusted.

It should be noted that each one of the above properties provides its own advantages, independently of any fulfillment of the other properties. Above, and in the following, the term “deployer” should be interpreted as someone deploying a service, i.e. a deploying party, typically an Application Service Handler.

### SUMMARY OF THE INVENTION

An object of the invention is to provide security when managing position data recorded by an electronic pen such that at least one of the above listed properties of a secure service is obtained.

This object is achieved by methods, computer program products and a system as defined in the independent claims. Advantageous embodiments are defined in the dependent claims.

According to embodiments of the invention, an electronic pen associates different areas of a position-coding pattern having position data destined for different Application Service Handlers with respective encryption keys, which associations enable the electronic pen to encrypt recorded position data belonging to a certain area of the pattern with the associated encryption key.

Thus, by means of the associations it can be ensured that only the Application Service Handler (ASH) holding an encryption key corresponding to the encryption key used for encrypting the recorded position data, can utilize the recorded position data, for any other recipient the encrypted data will remain secret.

The associations between areas of the pattern and encryption keys may be provided by respective ASHs, or administrators thereof, deploying secure services. Each association may be provided to a pen by means of a Pen Application License, PAL, which stores license data including an area specification that defines an area of the pattern and an encryption key, the corresponding encryption key being installed in the ASH. By means of providing an electronic pen with a PAL, the ASH is able to deploy a service in which information is securely encrypted without the need to interact with any other intermediate nodes or servers, at the time of deployment of the service, in the system.

Another general advantage is that secure services can be implemented in a system infrastructure that provides only one-way communication of the electronic pens, i.e. where pens cannot be configured for secure communication by other infrastructure components, such as an intermediary server or an ASH.

In one embodiment, asymmetric encryption is used for communicating data from the pen to the ASH. Thus, the encryption key of the PAL may be a public key of an asymmetric key pair, and the encryption key of the ASH may be the private key of said key pair.

According to an embodiment, use is made of PAL validation data in the PAL, against which a pen validates parameters of the PAL, to enable a controlling actor which has the right to manage a certain part of the position-coding pattern to control how that part, or different sub-areas thereof, are used in the system. The PAL validation data may be provided by the controlling actor to an ASH at, in principle, any time. When the ASH wants to deploy a service, it may generate a PAL including the PAL validation data, which then is provided to one or more electronic pens. For example, a parameter defining a range of pen identifiers, which parameter may be included in the PAL as well as in the PAL's PAL validation data, can be used to control the specific set of electronic pens that are allowed to operate on the certain part of the position-coding pattern. Similarly, a parameter defining a validity period, allows controlling for how long a certain part of the position-coding pattern may be used. The validity period may be defined as a time period, or, alternatively, as the maximum number of times that the certain part of the position-coding pattern may be used together with the service.

According to yet an embodiment, an ASH can at any time provide its encryption key, which is to be associated with an area specification in a PAL, to the controlling actor discussed above. This controlling actor may itself be an actor which can be trusted by electronic pens. This trust may come from that the pen has a public encryption key installed, at manufacture or initial configuration of the pen, which corresponds to a corresponding private encryption key of the trusted actor. Using its private encryption key, the trusted actor will sign the received encryption key from the ASH and return the thus-generated digital signature.

Alternatively, the controlling actor is just an intermediary controlling actor and the pens can only trust another party, which is the party with the private key corresponding to the pen's public key. In this latter case, the intermediary controlling actor in turn needs to transmit its public key to another actor, which may be the party that is trusted by the pen, or which may be yet another intermediary controlling actor. In return, the intermediary controlling actor will receive its public key digitally signed by said another actor in its capacity of either a trusted party or intermediary controlling actor. The intermediary controlling actor will digitally sign, using its private key, the encryption key received from the ASH. The resulting signature is then conveyed to the ASH, together with the signature received from said another actor.

The ASH will include all received digital signatures in the PAL, resulting in that a pen may use its stored public key of the trusted party to validate the chain of digital signatures included in the PAL, in turn resulting in a validation of the ASH's encryption key included in the PAL and associated with the area specification. In this way, a pen can trust any ASH deploying a new service, provided that the ASH is trusted by the trusted party, either directly or indirectly.

According to yet an embodiment, each digital signature may alternatively be generated by also digitally signing the license data included in the PAL and in the PAL validation data part. By validating the signed license data parameters, the pen can ensure that the ASH has the right to deploy a service in accordance with what is stipulated by the parameters. At the same time, such a scheme gives the trusted party the possibility to control in what way an ASH is allowed to use a specific pattern area in connection with a service.

Further features of the invention, as well as advantages thereof, will become more readily apparent from the following detailed description of a number of exemplifying embodiments of the invention. As is understood, various modifications, alterations and different combinations of features coming within the scope of the invention as defined by the appended claims will become apparent to those skilled in the art when studying the general teaching set forth herein and the following detailed description.

### BRIEF DESCRIPTION OF THE DRAWINGS

Exemplifying embodiments of the present invention will now be described with reference to the accompanying drawings, in which:

FIG. 1A schematically shows a system infrastructure developed by the applicant in which an exemplifying embodiment of the present invention is included;

FIG. 1B shows an example of a logical division of a virtual position surface for use by the system infrastructure of FIG. 1A;

FIG. 2 is a flow chart describing the operation of an Application Service Handler in accordance with the embodiment described with reference to FIG. 1;

FIGS. 3-4 are flow charts describing the operation of an electronic pen in accordance with the embodiment described with reference to FIG. 1.

### DETAILED DESCRIPTION OF THE INVENTION

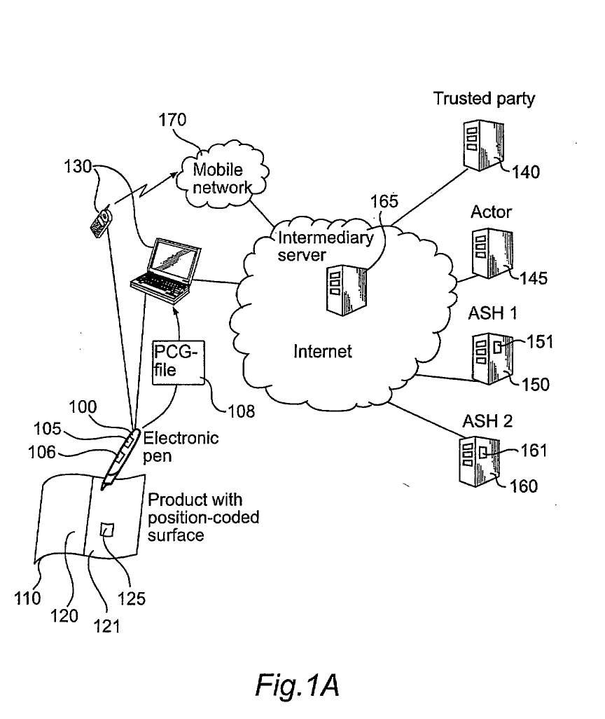

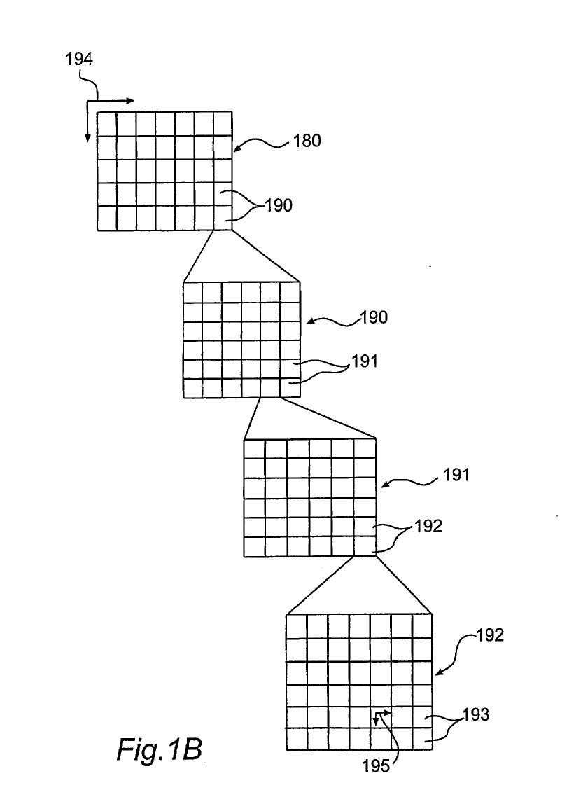

FIG. 1A shows a system infrastructure developed by the Applicant and in which an embodiment of the present invention is implemented. This infrastructure has been described above in the background section and will be further described below.

The system in FIG. 1A comprises electronic pens 100, or user units, and a plurality of products 110 with a position code (not shown) covering a writing surface 120, 121 and a functional area, or activation icon, 125. In the Figure, only one electronic pen and one product are shown. The system also comprises network connection units 130 and two Application Service Handlers, ASH1 and ASH2, denoted 150 and 160, respectively. The Application Service Handlers 150 and 160 are servers controlled by third parties for managing services that can be used by the electronic pens 100. Each of the Application Service Handlers, ASH1 150 and ASH2 160, includes processing means denoted 151 and 161, respectively, for controlling the ASH to operate in accordance with the invention. These processing means are typically implemented by means of the single or plurality of processors normally included by a computer operating as a server.

Furthermore, the system comprises a server 140 of a trusted party, i.e. a party that can be trusted by the electronic pens 100, and a controlling actor 145 which has the right to manage a certain part of the position coding pattern. The controlling actor 145 may itself be an Application Service Handler, or may be a server which is used for enabling different Application Service Handlers to deploy their services in the system with regard to the part of the position-coding pattern managed by the controlling actor 145.

In FIG. 1A the network connection unit 130 is exemplified as a mobile station or a laptop computer. However, the unit 130 could alternatively be a personal digital assistant (PDA), a stationary desktop computer, a LAN access point, or some other suitable electronic device. The network connection unit 130 may include a device application via which the electronic pen may communicate with other parts of the overall system. Typically, the described system will in addition to a plurality of electronic pens 100 and products 110 include a plurality of network connection units 130 and a plurality of Application Service Handlers 150, 160.

By detecting symbols of the coding pattern on the product 110, the electronic pen is able to determine one or more absolute co-ordinates of the total, virtual surface that can be coded by the coding pattern. It is to be understood that the virtual surface is huge, typically in the range of 1-10⁷ km².

The virtual surface is logically subdivided into individually addressable units. An example is given in FIG. 1B, where the virtual surface 180, or part thereof, is partitioned into a hierarchical structure of page units. Specifically, the virtual surface 180 is divided into a number of segments 190, each segment 190 being divided into a number of shelves 191, each shelf 191 being divided into a number of books 192, and each book 192 being divided into a number of page units or pattern pages 193. The pen is capable of correlating a determined absolute position to a certain area or part of the position-coding pattern, and to a certain local position within that area or part. Such an area or part is in this example a certain pattern page, which is identified using the format: segment.shelf.book.page (e.g., 1.2.3.4 would denote pattern page 4 of book 3, on shelf 2, in segment 1). This notation defines a page address. Thus, each determined absolute position in the global coordinate system 194 of the virtual surface represents position data which may be interpreted as a logical position within the virtual surface in the form of a page address and a local position within a pattern page 193, given in a local coordinate system 195.

In the following, the page address format is not only used to identify a specific pattern page, but also to identify a range of pattern pages, by using the notation 1.2.3.x, 1.2.x.x, or 1.x.x.x, where x denotes all pattern pages of a specific book, shelf, and segment, respectively. This addressing scheme is further described in aforesaid US 2003/0061188, referenced by way of introduction. It is to be understood that other partitions of the virtual surface and other addressing schemes are equally possible and that such partitions and addressing schemes also would fall within the scope of the present invention.

When a user moves the electronic pen 100 across the surface of the product 110, the pen records information by detecting symbols on the surface and determining the corresponding absolute co-ordinates. The information will typically be a page address and a sequence of locations on the relevant pattern page. This is accomplished by means of a sensor and various memory and processing circuitry included within the pen 100. The electronic pen typically stores definition data, which allows the pen to derive the relevant page address based upon the recorded absolute coordinates. This information, or position data, may be communicated via the network connection unit 130, and possibly via a mobile communications network 170, to an intermediary server 165.

As shown in FIG. 1A, the intermediary server 165 may be a server connected to the Internet and adapted to route the information, based on the page address, to a network address of a relevant ASH. However, this routing functionality may alternatively be included in the device application executed by the network connection unit 130, which includes a routing table for directing the information to the network address of the relevant ASH.

Thus, the functionality of the pen is at least partly controlled by the user operating the pen on a specific part of the position-coding pattern. The pen stores different templates that define how the information that is recorded from different parts of the position-coding pattern is to be interpreted. For example, a specific subset in the page hierarchy, e.g. a segment 190 or a shelf 191, may be associated with a template, which thus is valid for all pattern pages 193 within that specific subset. The template defines the size, placement (in coordinate system 195) and function of any functional areas (“pidgets”) that may affect the operation of the pen.

In a template, all positions not occupied by a pidget within a pattern page are defined as belonging to a drawing area. The positions detected in the drawing area are interpreted by the pen to be recorded and stored as pen strokes.

When the user of the electronic pen 100 wishes to initiate transmission of information he may “tick” the send area 125. The recording of at least one position of the send area 125 will then, by means of the template, be recognized by the electronic pen 100 as a position within a send pidget, which is associated with a particular send instruction.

Other pidgets may define a device selection area which identifies the network connection unit 130 to be used by the pen, i.e. whether it should be a PC, a mobile device, a LAN access point etc. In addition, the template may combine the functions of a plurality of pidgets in one and the same pidget. For example, the pidget corresponding to send area 125 may be defined to be associated with a mobile telephone as network connection unit.

As will be explained in further detail below, the pen preferably stores a Pen Application License, PAL, which defines a specific association between a pattern area specification and a public encryption key. Typically, within a certain pattern part (e.g. a segment or shelf), different areas in that part (e.g. pattern pages or books) are associated with different public encryption keys by means of several PALs. Advantageously, a template for such a certain pattern part is configured such that it can be dynamically associated with, or include, a number of different PALs, each defining a public encryption key for a respective area in that pattern part. A PAL is typically installed in the pen in a specific upgrade session which results in the PAL, or data derived therefrom by the pen, being stored in pen memory. Thereafter, the pen is able to execute secure services on all pattern pages that are supported by the thus-installed PAL data.

In one embodiment, the pen 100 has a pen-shaped casing or shell that defines a window or opening, through which images are recorded. The casing contains a camera system, an electronics system and a power supply.

The camera system comprises at least one illuminating light source, a lens arrangement and an optical image reader (neither shown). The light source, suitably a light-emitting diode (LED) or laser diode, illuminates a part of the area that can be viewed through the window by means of infrared radiation. An image of the viewed area is projected on the image reader by means of the lens arrangement. The image reader may be a two-dimensional CCD or CMOS detector which is triggered to capture images at a fixed or variable rate, typically of about 70-100 Hz.

The electronics system comprises processing means 105 which are connected to memory means 106. The processing means are responsible for the different functions in the electronic pen and can advantageously be implemented by a commercially available microprocessor such as a CPU (“Central Processing Unit”), by a DSP (“Digital Signal Processor”) or by some other programmable logical device, such as an FPGA (“Field Programmable Gate Array”) or alternatively an ASIC (“Application-Specific Integrated Circuit”), discrete analog and digital components, or some combination of the above. The memory means 106 may comprise different types of memory, such as a working memory (e.g. a RAM) and a program code and persistent storage memory (a non-volatile memory, e.g. flash memory). Associated software is stored in the memory means 106 and is executed by the processing means 105 in order to provide a pen control system that handles the operation of the electronic pen in general, but also the operation of the pen in accordance with the present invention. The memory means 106 holds a public encryption key, which has been provided to the pen at manufacture or initial configuration of the pen. This public key corresponds to a private key possessed by an actor in the system. By virtue of this private/public key pair with matching keys, this actor will by the pen be regarded as a trusted party 140 in the system.

The casing of the pen 100 also carries a pen point which allows the user to write or draw physically on a surface by pigment-based marking ink being deposited thereon. The marking ink in the pen point is suitably transparent to the illuminating radiation in order to avoid interference with the opto-electronic detection in the electronic pen. A contact sensor is operatively connected to the pen point to detect when the pen is applied to (pen down) and/or lifted from (pen up), and optionally to allow for determination of the application force. Based on the output of the contact sensor, the camera system is controlled to capture images between a pen down and a pen up. The resulting sequence of temporally coherent positions forms an electronic representation of a pen stroke.

The electronics system of the pen further comprises a communications interface which is controlled by the processing means 105 for outputting a file 108 with information data to the network connection unit 130. It should be noted that the network connection unit need not be a local unit, but may be implemented by a remote unit, such as a network server etc. The communications interface may thus provide components for wired or wireless short-range communication (e.g. USB, RS232, radio transmission, infrared transmission, ultrasound transmission, inductive coupling, etc), and/or components for wired or wireless remote communication, typically via a computer, telephone or satellite communications network.

Still further, the pen may include one or more buttons (not shown) by means of which it can be activated and/or controlled.

Typically, the electronic pen 100 is configured to generate the above-mentioned file 108 with all relevant information data. Such information data may include position data that it has read from a position-coded surface, as well as data relating to different properties stored by the pen. The file is then to be transferred to the network connection unit 130 for routing, possibly via the intermediary server 165, to a receiving ASH. Transfer of the file to the network connection unit 130 may be effectuated by “ticking” the send area 125, or be automatically performed when connecting the electronic pen to the network connection unit 130. The transferring of the file may alternatively be effectuated when the pen registers a voice command or the pushing of a button on the pen.

The electronic pen could for example be designed to push the file with information data to the device application in the network connection unit 130 by means of an OBEX push (Object Exchange protocol), which is a standardized protocol known to the skilled person. Alternatively, the electronic pen could allow the device application to pull the file from the pen. For example, the file may be stored in a file system in the memory means 106, the file system being accessible to the device application via, e.g., USB (Universal Serial Bus), FTP (File Transfer Protocol), HTTP (Hypertext Transfer Protocol) or any other suitable protocol.

The file 108 outputted by the electronic pen 100 typically includes at least a page data part and a property data part. A file having a format which includes such parts has been defined by the present Applicant and has been allotted the name Pen Generated Co-ordinate file, or PGC file, making it a proprietary format of the applicant. The property data part includes property parameters stored in the pen, e.g. the pen's unique identity, the version of the software used by the pen, the identity of the pen manufacturer, and various information specific to a user of the electronic pen, such as his name, invoice address, e-mail address, and so on. Routing of the file to an ASH could be based on a page address. However, routing of the file could alternatively be based on any other parameter of the property data in the file. For example, the intermediary server 165, or alternatively the network connection unit 130, could include a routing table translating a pen's identity or a user's e-mail address to a network address of a certain ASH.

The PGC file format, as well as the controlling software and circuitry of the pen for generating and exposing such a file is further described in Applicant's co-pending International patent application No. PCT/SE2005/001025, filed on Jun. 29, 2005, which is herewith incorporated by this reference.

To allow for secure transfer of the information data in the file 108, a specific area of the position-coding pattern from which the position data is recorded by the pen is associated with a specific public encryption key. The associations between different areas of the pattern and different public keys may be provided by respective ASHs 150, 160, or administrators thereof, deploying secure services. Each association is provided to a pen by means of a Pen Application License, PAL, which stores a pattern area specification defining an area of the pattern and a public key, the corresponding private key being installed in the ASH. These keys could be used for encryption/decryption according to any known public-key algorithm, such as the Diffie-Hellman (DH) algorithm or the Rivest-Shamir-Adleman (RSA) algorithm.

Before describing exemplifying operations of the ASH and the electronic pen in accordance with embodiments of the invention, the data structure defining a PAL format will be introduced and briefly described.

The general structure of a PAL is shown below:

| Data fields | Explanation |
|---|---|
| PAL validation data | Data of actor controlling |
| | pattern concerned |
| Public key | The public key associated with |
| | pattern area specification in |
| | License data |
| License data | various parameters, typically: |
| | validity period; |
| | range of pen identifiers; |
| | pattern area specification |
| Signature of Public key | Created with private key of |
| and License data | actor controlling pattern |
| | concerned |

The PAL validation data field includes data received from an actor in control of a relevant part of the pattern. This controlling actor or authorizer has the right to control generation of PALs for this actor pattern part. To exemplify, an ASH generating a PAL for a pattern area included in the actor pattern part, will in this field of the PAL include data providing license boundaries determined by the controlling actor, such as a pattern area specification, range of pen identifiers, validity period, etc. The parameters of the PAL validation data field correspond to the parameters included in the license data field of the PAL. Also, the PAL validation data will include the public key of an asymmetric key pair of the controlling actor, as well as a digital signature received from the controlling actor, as will be further described below.

The PAL validation data that the controlling actor provides to the ASH has the same fields as the above PAL structure, i.e. it in turn includes the fields Public key, License data and Signature, as well as further PAL validation data received from a superordinate controlling actor, if such is present. This superordinate controlling actor has the right to control at least the aforesaid actor pattern part and may allow a subordinate controlling actor, i.e. the controlling actor discussed above, to also control this part. Alternatively, if the above-discussed controlling actor is the first actor that has acquired the right to control the actor pattern part from the party trusted by the pen, or if this controlling actor is the trusted party itself, the PAL validation data does not include yet further PAL validation data, but this field will have a “null” value.

Thus, there may be a hierarchy of controlling actors for a certain pattern area, for example, by each actor controlling a relevant pattern part on a respective level in the above-mentioned page hierarchy. With a hierarchy of controlling actors, the PAL validation data field of the PAL may include a chain of PAL validation data, where each link in the chain relates to a respective controlling actor in the hierarchy. For example, each link of PAL validation data may define license boundaries and a public key of the respective controlling actor, as well as a digital signature received from the respective superordinate controlling actor in the hierarchy.

Returning now to the PAL structure, the Public key field of the PAL includes the public key of a private/public encryption key pair generated by, or stored at, an ASH. This ASH public key is implicitly associated with a pattern area specification parameter in the License data field. This area specification defines the pattern area within which an electronic pen is allowed to record position data when using the secure service. The pattern area is defined by means of one or more page addresses or a range of page addresses. The License data field may include a number of further license boundary parameters such as a validity period (e.g. from one date to another date) and a range of pen identifiers.

The Signature field of the PAL includes a digital signature of the ASH public key and, possibly, also of license data of the PAL. This signature has been generated by the controlling actor using the private key of an asymmetric encryption key pair of the controlling actor.

As stated, the PAL validation data field in turn includes the same fields as the PAL structure. However, its public key is not to be used by a pen to encrypt any recorded position data, but is to be used for validating the digital signature of the PAL. The use of the PAL validation data by means of a pen when validating a PAL will be further described below.

In a variant of the above, an explicit destination address of the relevant ASH is also included in the PAL, and is thereby implicitly associated with the area specification therein. The destination address may be given as a network address such as a URL (Uniform Resource Locator), an electronic mail address, an IP (Internet Protocol) address, etc. By including such an address in the PAL, routing in the system infrastructure may be simplified. In one example, the pen may push the PGC file 108 directly to the relevant ASH. In another example, the pen may include the explicit destination address in the file 108, to allow the intermediary server 165 or the network connection unit 130 to operate directly on this address to route the file to the relevant ASH. Thereby, the need to maintain routing tables in the system is reduced.

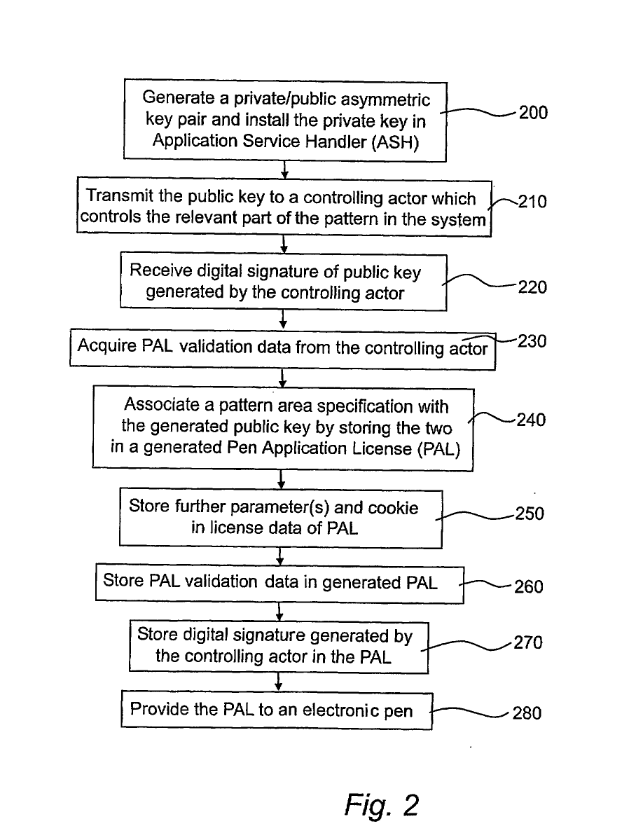

With reference to FIG. 2, an exemplifying operation of an ASH included in the system of FIG. 1A, and which operation concerns the deployment of a secure service in the system, will now be described.

The operation is described below as being performed by the ASH. However, it should be understood that some of the actions could be performed by an administrator of the ASH, using an appropriate programming tool, as an alternative to have the ASH performing those actions automatically.

The ASH, e.g. ASH1 150, wanting to deploy a service, immediately or sometimes in the future, generates a private/public encryption key pair and stores the private key (step 200). ASH1 150 then transmits the public key to a controlling actor, e.g. actor 145, known by ASH1 to have the right to control, and to have the right to issue Pen Application Licenses for, the part of the position-coding pattern which covers the pattern area that ASH1 wishes to associate with its service(s) (step 210). The controlling actor has its own private/public encryption key pair. Using its private key, the controlling actor 145 will digitally sign the public key received from ASH1, and return the signed key to ASH1 (step 220). Next, ASH1 acquires PAL validation data from the controlling actor (step 230). In case the controlling actor 145 is not a party trusted by the pen, the PAL validation data will include a digital signature of the controlling actor's 145 public key, which has been generated by the trusted party 140 using a private key corresponding to the public key being pre-stored in the electronic pens. Alternatively, the PAL validation data includes a chain of such digital signatures starting with a digital signature generated by the trusted party 140, consisting of a digitally signed public key of an intermediate controlling actor (not shown), and ending with the digital signature generated by another intermediate controlling actor (not shown), consisting of a digitally signed public encryption key of the controlling actor 145. ASH1 150 is now able to at any time generate a PAL, include its public key digitally signed by the controlling actor 145, and, if needed, include PAL validation data with a chain of digital signatures. This PAL can then be provided to electronic pens and be validated by the same.

Assume now that ASH1 wishes to deploy a new secure service. ASH1 selects the template to be used for the service and defines the pattern area specification, in the form of one or more page addresses, to be used with the service, e.g. page addresses covering the pattern area 120 which is printed on the surface of product 110. The area specification is associated with the public key of the private/public encryption key pair of ASH1 by means of storing the area specification and the public key in a data structure having the PAL format discussed above (step 240). Next, license parameter(s) other than the area specification, and possibly a so-called cookie, may be stored in the PAL (step 250). Examples of such license parameters have been discussed above. The values or ranges of the license parameters may not exceed the values or ranges of the corresponding parameters in the PAL validation data. If they do, the electronic pen will later not be able to validate the PAL during installation of the same. The cookie may typically define information to be sent together with position data recorded from the position-coding pattern defined by the pattern area specification. Such information may include one or more of the above-mentioned property parameters stored in the pen.

ASH1 150 then stores PAL validation data in the PAL (step 260). Even though not indicated in the flow chart in FIG. 2, ASH1 may also transmit license data parameters stored in the PAL to the controlling actor 145, so that the actor can sign these parameters with its private key, and return the resulting digital signature to ASH1. It will be appreciated that the operation may be such that this digital signature is the result of the controlling actor 145 signing both the public key and the license data parameters of the PAL at the same time. Next, ASH1 stores the digital signature generated by the controlling actor 145 and transferred to ASH1 (step 270). The PAL is now completed and may be provided as a file for use by an electronic pen 100 (step 280).

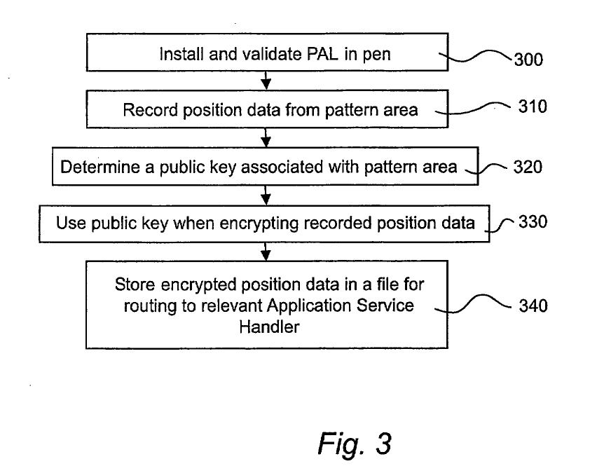

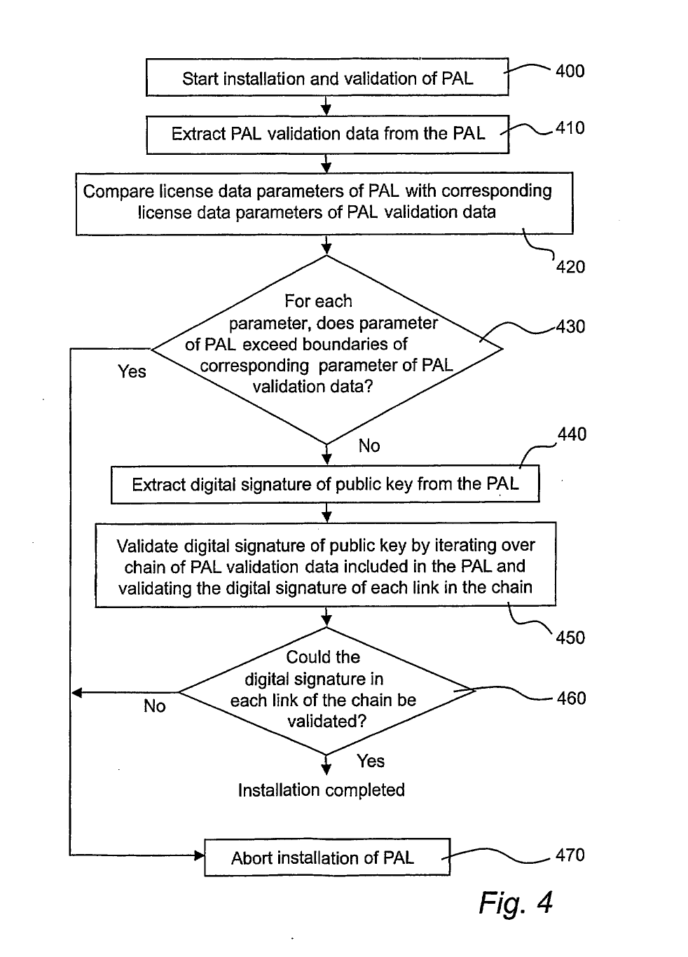

With reference to FIGS. 3 and 4, an exemplifying operation of an electronic pen 100 included in the system of FIG. 1A will now be described.

A user of a pen, such as the electronic pen 100, that wishes to use a specific service provided by an ASH, such as ASH1 150, initiates installation of a corresponding Pen Application License, PAL. This is e.g. done by browsing different services using the network connection unit 130 and selecting a corresponding PAL for download by clicking on a link in the browser window, after which the network connection unit 130 transfers the PAL to the electronic pen 100 for storage in the memory means 106. Other ways of downloading a PAL file into the pen will be appreciated by a person skilled in the art. Upon receiving the PAL, the electronic pen installs and validates the PAL in the pen (step 300).

Having a PAL of a specific service installed in the pen, the pen may then start to use that service. Typically, use of the service starts with the pen recording position data from a pattern area on the product 110, which pattern area is intended for use with the service (step 310). Having recorded position data from the surface, the user may tick the send area 125 to initiate transfer of recorded information to the ASH providing the service, e.g. ASH1 150. As discussed above, the recorded position data, or co-ordinates, of the area 120 will identify a specific page address. The pen, by means of the included processing means 105, will then check among its stored PALs for a PAL associated with the page address (step 320), via the pattern area specification in the PAL.

Next, the processing means 105 derives the public key from the thus-identified PAL, and uses this public key to encrypt the information data which is to be transferred to ASH1 (step 330). Such encryption can be accomplished in a number of ways. According to one embodiment, to minimize the computational complexity, the pen generates and uses a random session key, such as a symmetric key with which the information data is encrypted. This random session key is then encrypted using the public key of the PAL. In this way, ASH1 will later be able to use its installed private key to decrypt the encrypted session key, and then the decrypted session key to decrypt the encrypted information data.

The information data encrypted with the public key is then stored in a Pen Generated Co-ordinate file, PGC file, which file has been described above, for routing to ASH1 (step 340). The routing is either accomplished by the intermediary server 165 or the network connection unit 130, as discussed above. To enable the routing, the page address of the position data may be stored non-encrypted in the PGC file, thereby enabling routing based on the page address. However, the skilled person will appreciate that routing may be performed based on a number of alternative parameters that may be stored un-encrypted in the PGC file, such as one of the pen property parameters retrieved from the pen, e.g. the unique pen identifier or the e-mail address of the user of the pen. Still further, routing may be performed based on an explicit destination address derived from the PAL and stored in the PGC file.

The electronic pen may typically install yet another second PAL to be able to use a service provided by ASH2 160 with regard to another area of the position-coding pattern, such as the pattern area depicted with reference number 121 in FIG. 1A. The installation of the second PAL and use of the service provided by ASH2 correspond to that described above with regard to ASH1. The electronic pen may install multiple further PALs to be used in connection with multiple services with regard to multiple pattern areas.

With reference to the flow chart in FIG. 4, step 300 in FIG. 3 relating to installation and validation of the PAL in a pen will now be further described.

The installation and validation of the PAL starts (step 400) by the pen extracting the PAL validation data from the PAL (step 410). Next, the pen compares each of the license data parameters of the PAL with the corresponding parameter of the PAL validation data (step 420), and checks that each such license data parameter does not exceed the boundaries (i.e. that it is a subset) of the corresponding parameter of the PAL validation data (step 430). If any of the license data parameters exceeds such a boundary, the pen aborts installation of the PAL (step 470). If not, the installation continues. Here, the pen may also need to verify that its pen identifier falls within the range of pen identifiers set by the license data of the PAL, and/or that the current time, given by a time circuit in the pen, falls within the validity period set by the license data of the PAL.

Next step in the continued installation involves extracting a digital signature of the public key from the PAL (step 440). This public key of the PAL is validated by iterating over a chain of PAL validation data with digital signatures of public keys and validating the public key in each link of the chain (step 450). The iteration starts with validating the public key of the top-most PAL validation data, which public key has been digitally signed by the party trusted by the pen, by using the trusted party's public key, which is pre-stored in the pen. The thus-validated public key is then used to validate the next public key of a digital signature in the chain of PAL validation data, until the public key of the PAL itself may be validated. Each such validation step may be performed based on decrypting and calculating checksums as is well known to the skilled person. In case a public key in the chain cannot be validated (step 460), the installation is aborted (step 470).

Alternatively, the iteration in step 450 could include checking, for each link in the chain and starting at the top-most link, that each parameter in the license data field of the PAL validation data is a subset of the corresponding parameter in the PAL validation data of a previous link, which validation data is included in the PAL validation data of a current link. Also, such license data parameter(s) of each link may be encrypted together with the public key, wherein the validation of the parameters in each link also includes decrypting the parameters and comparing these with the parameters in clear text. If any parameter in any link does not pass the validation, the installation is aborted. To be able to validate the top-most link in this manner, the iteration starts with setting the parameter Pattern area specification=“entire pattern”, Range of pen identifiers=“all pens”, Validity period=“forever”.

The above validation may alternatively be executed in an external application, e.g. in a download station connected to the pen, which receives and validates each PAL according to the above methodology. After successful validation, the external application may provide all or selected PAL data to the pen.

Finally, a simple example further describing an exemplary embodiment of the invention will now be discussed, again with reference to FIG. 1A.

Assume that controlling actor 145 has agreed with the trusted party 140 to control the use of a complete segment of the position-coding pattern, for example segment 17, during a 10 year period, e.g. from Jan. 1, 2005 to Dec. 31, 2014. Using the notation described above, the segment in question can be identified as 17.*.*.*, thereby indicating, using the wild card “*”, all shelves of that segment, all books of those shelves, and all pattern pages of all books. Assume further that controlling actor 145 in other respects should be in complete control of segment 17, i.e. there should be no restrictions on its use apart from the 10 year validity period. To acquire the PAL validation data from the trusted party 140, the controlling actor 145 transfers its public key of an asymmetric key pair to the trusted party. In addition, the controlling actor may transfer a set of license data parameters. In response thereto, the controlling actor 145 will receive a digital signature generated by the trusted party 140 by means of a private key corresponding to a public key pre-stored in all pens 100 in the system. The trusted party generates the signature by using its private key to sign the controlling actor's public key, and possibly also the controlling actor's license data. The controlling actor 145 will then assemble a set of PAL validation data having the fields as described above, and the resulting PAL validation data will look like:

| Data fields | Content |
|---|---|
| PAL validation data | Null |
| Public key | The public key of the controlling |
| | actor's 145 asymmetric key pair |
| License data | Validity period = |
| | “2005-01-01-2014-12-31”; |
| | Security level = “any”; |
| | Range of pen identifiers = “any”; |
| | Pattern area specification = |
| | “17.*.*.*”; |
| | Stand-alone = “yes”; |
| | Sublicense = “yes”. |
| Signature of above | Created with private key of |
| Public key and above | trusted party 140 controlling |
| License data | pattern concerned |

In this example the license data includes the additional parameters “Security Level”, “Stand-alone” and “Sublicense”. The “Security Level” parameter sets the boundaries for a later generated PAL with regard to security, i.e. allowing non-encryption as well as encryption of data communicated from a pen in connection with the use of a service. The “Stand-alone” parameter indicates whether a PAL can be generated without including a digital signature of the public key and the license data of the PAL, provided that the PAL validation data is included in the generated PAL. This option allows an ASH to generate a PAL without further interaction with the controlling actor, thereby simplifying deployment at the cost of reduced security. Finally, the “Sublicense” parameter indicates whether the controlling actor may allow another actor, or an ASH, to generate PAL validation data within the license boundaries concerned.

The controlling actor 145 may now distribute the PAL validation data to potential service deployers, i.e. to potential ASHs.

Assume now that ASH1 previously has received the above PAL validation data and now wishes to generate a PAL for a service to be associated with segment 17. ASH1 may then at any time generate a PAL having license data parameters which does not exceed the boundaries of the PAL validation data. Should the PAL include parameter(s) exceeding these boundaries, validation of the PAL in the electronic pens will fail. The fields of the PAL generated by ASH1 could have the following data:

| Data fields | Content |
|---|---|
| PAL validation data | PAL validation data assembled by |
| | controlling actor 145 |
| Public key | The public key associated with the |
| | pattern area specification in |
| | License data field |
| License data | Validity period = |
| | “2005-01-01-2014-12-31”; |
| | Security level = “encrypt”; |
| | Range of pen identifiers = “any”; |
| | Pattern area specification = |
| | “17.*.*.*”; |
| | Stand-alone = “yes”; |
| | Sublicense = “no”. |

It may be noted that, because of the “Stand-alone” parameter having value “yes”, ASH1 need not include a digital signature of its public key and license data parameters in the PAL. This enables ASH1 to generate a PAL at any time, without any interaction with the controlling actor 145, or the trusted party 140.

Upon validating the above PAL in a pen, the pen will validate the digital signature of the PAL validation data using its pre-stored public key, retrieve the license data from the PAL validation data and then check that each parameter of the license data of the PAL does not exceed the boundaries of the corresponding license data parameter in the PAL validation data. After validation, the pen will use the public key of the PAL to encrypt all outputted position data recorded from segment 17.

It should be noted that the detailed description above of different embodiments of the invention has been given by way of illustration only and that these therefore are not intended to limit the scope of the invention, as it is defined by the appended claims. Furthermore, it will be appreciated that various alterations and modifications falling within the scope of the appended claims will become apparent to those skilled in the art when studying the claims and the detailed description.

For example, it is to be understood that the principles of the invention are applicable irrespective of the pen's method of communication in the system infrastructure. For example, instead of outputting a file, the pen may output recorded data in real time to the system infrastructure. The pen may also be capable of communicating with infrastructure components using a two-way protocol.

Further, the above described asymmetric encryption techniques (public-key algorithms) could be replaced for symmetric encryption techniques, e.g. based on DES, RSA or IDEA algorithms. For example, the pen and ASH could share a symmetric encryption key, via the PAL installed in the pen. Similarly, one or more digital signatures included in the PAL could be based on symmetric encryption.

It is to be understood that the PAL could have any suitable format. The PAL may contain object code or scripts, to be executed either by the pen control system for validation of the PAL and storage of relevant PAL data, or by an external application in a download station connected to the pen, which validates the PAL and provides relevant PAL data either to the pen control system or directly to pen memory. Alternatively or additionally, the PAL may contain data in an information-sharing format, which may be tagged or non-tagged, character-encoded or non-character-encoded (e.g. binary), for similar processing by the external application and/or the pen control system.

In the above embodiments, the division of the position-coding pattern is dynamic, in that the pattern only codes absolute positions which are converted to logical positions using definition data stored in pen memory. In an alternative embodiment, the division of the pattern may be static, by being encoded in the pattern. For example, U.S. Pat. No. 6,330,976 discloses a coding pattern in which coding cells are tiled over the product surface, each cell coding both a local position and a page identifier. The pen is thus capable of directly inferring its logical position from the data encoded in the pattern.

The described embodiments may include features that provide distinct advantages without also being connected to the distribution of encryption keys in a system infrastructure. Such features include, but are not limited to, the disclosed concepts of validating a license file based on boundary data set by a controlling actor, by matching parameter(s) of the license file to corresponding parameters) of the boundary data; including a digital signature of a trusted party in a license file to allow a pen to validate the license file; using a chain of digital signatures for validating a license file, the chain representing a hierarchy of controlling actors; and using validation data provided by a controlling actor to authorize generation of a license file.

1. A method for providing security with regard to position data recorded by an electronic pen from a position-coding pattern, wherein the recorded position data are destined for a specific Application Service Handler, ASH, the method comprising:
generating a Pen Application License, PAL, which controls how electronic pens interact with the ASH; and providing the PAL for installation in an electronic pen,
wherein the step of generating a PAL includes storing, in the PAL, license data in association with a first encryption key, the license data including an area specification that defines an area of the position-coding pattern having position data destined for the ASH, the first encryption key corresponding to a second encryption key installed in the ASH,
thereby enabling the electronic pen to provide encryption of position data recorded within the area specification using the first encryption key.

2. The method of claim 1, wherein the first and the second encryption key is a public and private key, respectively, of an asymmetric key pair.

3. The method of claim 1, wherein the license data includes at least one further parameter of a group of parameters consisting of: a range of electronic pen identifiers, and a validity period for the PAL.

4. The method of claim 1, further comprising:
transmitting at least the first encryption key to an actor, for signing by the actor with a private key of an asymmetric validation key pair of the actor, the actor being authorized to control generation of PALs for a certain part of the position-coding pattern;
receiving, from the actor in response to the transmitting step, a digital signature of the first encryption key, which digital signature has been generated by the actor;
wherein the step of generating a PAL includes storing the digital signature as part of the PAL.

5. The method of claim 4, wherein the transmitting step includes transmitting the license data to the actor, and the receiving step includes receiving a digital signature generated by the actor, the digital signature consisting of a digitally signed version of the transmitted second encryption key and the transmitted license data.

6. The method of claim 1, further comprising storing a cookie in the PAL, the cookie defining information to be sent together with position data recorded from the part of the position-coding pattern defined by the area specification.

7. The method of claim 1, further comprising:
acquiring PAL validation data from an actor authorized to control generation of PALs for a certain part of the position-coding pattern, the PAL validation data including an area specification of said certain part, wherein the area specification of the PAL is defined so as to not exceed the boundaries of the area specification of said certain part,
wherein the step of generating a PAL includes storing the PAL validation data as part of the PAL.

8. The method of claim 7, wherein the area specification of the PAL validation data is included in a set of license data included by the PAL validation data, wherein the license data of the PAL validation data include at least one further parameter of a group of parameters consisting of: a range of electronic pen identifiers, and a validity period.

9. The method of claim 8, wherein the at least one further parameter in the license data of the PAL is defined so as to not exceed the boundaries of a corresponding parameter in the PAL validation data.

10. The method of claim 7, further comprising acquiring a digital signature of at least part of the PAL validation data and storing the digital signature as part of the PAL validation data in the PAL.

11. The method of claim 10, wherein the digital signature has been generated by a trusted party by means of a private key of an asymmetric key pair, the corresponding public key being pre-stored in the electronic pen to which the PAL is to be provided.

12. The method of claim 7, wherein the step of storing PAL validation data includes storing a chain of PAL validation data, each link of the chain representing an actor and including a public key of an asymmetric key pair of the actor and a digital signature of the public key generated by an actor representing the previous link, wherein the digital signature of the top-most link of the chain has been generated by a trusted party by means of a private key of an asymmetric key pair, the corresponding public key being pre-stored in the electronic pen to which the PAL is to be provided.

13. The method of claim 12, wherein each link of the chain of PAL validation data includes license data parameters defined so as to not exceed the boundaries of corresponding license data parameters of PAL validation data in a previous link of the chain.

14. The method of claim 4, wherein the actor of said transmitting step and said receiving step is a trusted party, and wherein the private key used by the trusted party for generating the digital signature correspond to a public key being pre-stored in the electronic pen to which the PAL is to be provided.

15. A computer-readable medium storing computer-executable components for causing a server to perform the steps recited in claim 1 when the computer-executable components are run on a computer device included by the server.

16. A method in an electronic pen for providing security when managing position data recorded from a position-coding pattern, wherein the recorded position data from different areas of the pattern are destined for different Application Service Handlers, ASHs, said method comprising:
recording position data from one of said areas of the position-coding pattern;
determining an encryption key which by the pen is stored in association with the area from which data were recorded, wherein the pen associates different areas of the position-coding pattern with different encryption keys; and
providing encryption of the recorded position data using the determined encryption key.

17. The method of claim 16, wherein each association between an area of the position-coding pattern and an encryption key is provided by means of a Pen Application License, PAL, which is installed for storage by the pen and which associates license data with the encryption key, the license data including an area specification that defines said area of the position-coding pattern.

18. The method of claim 17, including installing a PAL for each association between an area of the position-coding pattern and an encryption key.

19. The method of claim 17, wherein the license data includes at least one further parameter of a group of parameters consisting of: a range of electronic pen identifiers, and a validity period for the PAL.

20. The method of claim 17, wherein the PAL further includes a cookie which defines information to be sent together with position data recorded from the position-coding pattern defined by the area specification.

21. The method of claim 17, wherein the step of installing the PAL includes:
extracting PAL validation data included in the PAL, the PAL validation data including license data of an actor which has authorized the generation of the PAL to be installed;
validating, for each parameter in the license data of the PAL, that the parameter does not exceed the boundaries of the corresponding parameter in the license data part of the PAL validation data; and
aborting the installation if any such parameter exceeds the boundaries provided by the PAL validation data.

22. The method of claim 21, wherein the license data of the PAL validation data include an area specification, the validating step including checking that the area specification of the PAL is a subset of the area specification of the PAL validation data, and if it is not, aborting the installation.

23. The method of claim 21, wherein the license data of the PAL validation data include a set of electronic pen identifiers, the validating step including checking that a range of electronic pen identifiers included in the license data of the PAL is a subset of the set of electronic pen identifiers of the PAL validation data, if it is not, the installation is aborted.

24. The method of claim 21, wherein the license data of the PAL validation data include a validity period, the validating step including checking that the validity period included in the license data of the PAL is a subset of the validity period of the PAL validation data, and if it is not, aborting the installation.

25. The method of claim 17, the step of installing the PAL including checking that the electronic pen's own identifier is included in the range of electronic pen identifiers included in the license data of the PAL, if it is not, the installation is aborted.

26. The method of claim 17, wherein the step of installing a PAL includes:
extracting, from the PAL, a digital signature of the encryption key included in the PAL;
validating the digital signature in the PAL by iterating over a chain of PAL validation data within the PAL, wherein a digital signature of a public key of an asymmetric key pair at the top-most PAL validation data of the chain is validated using a public key of a trusted party which is pre-stored in the electronic pen, the top-most public key then being used to validate the next digital signature of a next public key in the next link of the PAL validation data chain, and iterating over the chain until the digital signature of the public key included in the PAL is validated; and
aborting the installation if any validation during the iteration fails.

27. The method of claim 16, including storing the encrypted position data recorded from the part of the position-coding pattern in a file generated by the electronic pen for routing to the corresponding Application Service Handler.

28. The method of in claim 27, wherein the step of providing encryption of the recorded position data includes:
generating a random session key;
encrypting the position data using the random session key;
encrypting the random session key using the encryption key, which is a public key that corresponds to a private key of an asymmetric key pair of an ASH to which the recorded data is destined; and
storing the encrypted random session key in the file generated by the electronic pen.

29. The method of claim 16, wherein the determined encryption key corresponds to a matching encryption key of an ASH to which the recorded data is destined.

30. The method of claim 16, wherein the determined encryption key is a public key that corresponds to a private key of an asymmetric key pair of an ASH to which the recorded data is destined.

31. A computer-readable medium storing computer-executable components for causing an electronic pen to perform the steps recited in claim 16 when the computer-executable components are run on a computer device included by the electronic pen.

32. A system for providing security with regard to position data recorded by an electronic pen from a position-coding pattern, wherein the recorded position data are destined for a specific Application Service Handler, ASH, the system including:
at least one ASH storing a private key of an asymmetric key pair; and
at least one electronic pen adapted to record position data from said position-coding pattern,
wherein each ASH includes:
ASH processing means for generating a Pen Application License, PAL, which controls how electronic pens interact with the ASH and for providing the PAL with license data in association with a public key, the license data including an area specification that defines an area of the position-coding pattern having position data destined for the ASH, the public key corresponding to the private key installed in the ASH,
and wherein each electronic pen includes:
memory means for storing at least one PAL generated by an ASH, wherein different areas of the position-coding pattern are associated with different public keys by means of respective PALs; and
pen processing means for determining, based on the stored at least one PAL, a public key associated with an area of the position-coding pattern from which data have need recorded; and
encryption means for providing encryption of the recorded position data using the determined public key.

33. (canceled)

34. (canceled)
